(19) United States
(12) Patent Application Publication
(10) Pub. No.: US 2015/0142675 A1
(43) Pub. Date: May 21, 2015

(54) ELECTRONIC PROCESS VALIDATION

(71) Applicant: GUARDIAN CONSUMER SERVICES, INC., Plano, TX (US)

(72) Inventors: Mark R. McElroy, Lewisville, TX (US); Mary H. Schuster, Plano, TX (US); James L. Hollis, The Colony, TX (US)

(73) Assignee: GUARDIAN CONSUMER SERVICES, INC., Plano, TX (US)

(21) Appl. No.: 14/085,698

(22) Filed: Nov. 20, 2013

(51) Int. Cl. G06Q 10/10; G06Q 50/16

(52) U.S. Cl. CPC G06Q 10/103; G06Q 50/167
USPC 705/301

(57) ABSTRACT

A system for electronic transaction processing, comprising a plurality of electronic documents, each having a plurality of elements, each element having one or more representation data field, one or more definition data field and one or more record data field, a consumer closing table providing access to a subset of the electronic documents and allowing a borrower that has been associated with the subset of the electronic documents to edit predetermined data fields and to view predetermined educational materials associated with one or more of the elements and a closing disclosure collaboration system configured to provide access to a closing disclosure document and to allow a settlement agent to edit predetermined data fields and to allow a lender to edit predetermined data fields.

### TECHNICAL FIELD

The present disclosure relates to data processing, and more specifically to an electronic process validation that allows different parties to collaborate for complex transactions.

### BACKGROUND OF THE INVENTION

Electronic data processing is known in the art, but often results in processes that are incorrect or confusing.

### SUMMARY OF THE INVENTION

A system for electronic transaction processing is provided that includes a plurality of electronic documents, each having a plurality of elements, each element having one or more representation data field, one or more definition data field and one or more record data field, a consumer closing table providing access to a subset of the electronic documents and allowing a borrower that has been associated with the subset of the electronic documents to view predetermined educational materials associated with one or more of the elements and a closing disclosure collaboration system configured to provide access to a closing disclosure document and to allow a settlement agent to edit predetermined data fields and to allow a lender to edit predetermined data fields.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a form used for electronic process validation in accordance with an exemplary embodiment of the present disclosure;

FIG. 2 is a diagram of an algorithm for creating a document for a transaction in accordance with an exemplary embodiment of the present disclosure;

FIG. 3 is a diagram of a system for a digital closing process in accordance with an exemplary embodiment of the present disclosure;

FIG. 4 is a diagram of a system for compliance management in accordance with an exemplary embodiment of the present disclosure;

FIG. 5 is a diagram of a system for order data access in accordance with an exemplary embodiment of the present disclosure; and

FIG. 6 is a diagram of an algorithm for managing a virtual closing environment in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

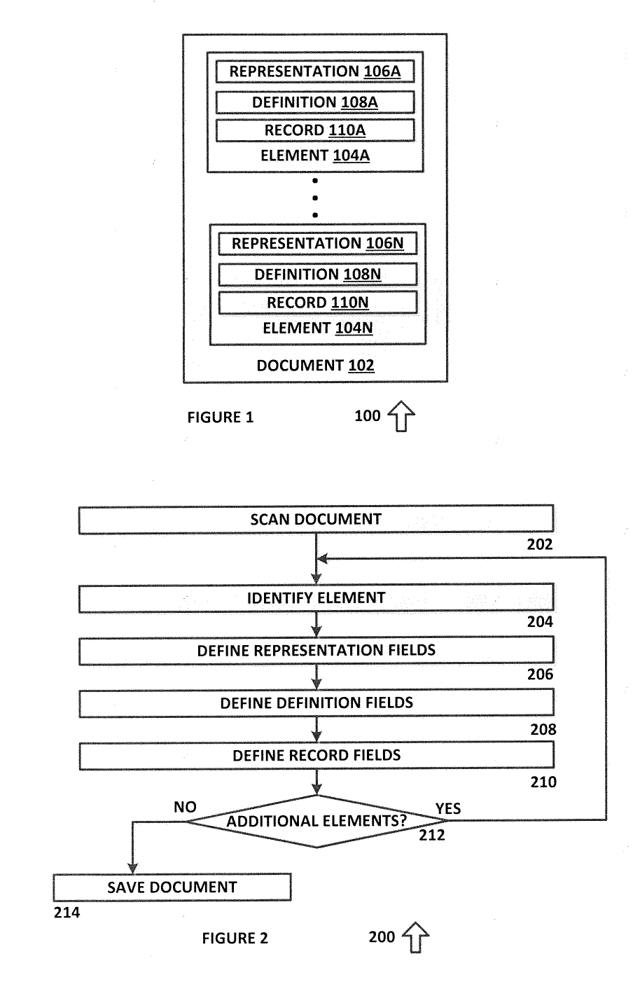

FIG. 1 is a diagram of a form 100 used for electronic process validation in accordance with an exemplary embodiment of the present disclosure. Form 100 can be implemented in hardware or a suitable combination of hardware and software, and can be one or more software systems operating on a processor.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as keyboards or mice, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

Form 100 includes document 102, which further includes a plurality of elements 104A through 104N. Element 104A includes a representation 106A, a definition 108A and a record 110A, each of which are generated when element 104A is generated. In one exemplary embodiment, form 100 can be a layered portable document format (PDF) document that includes associated XML data, such as a description, locations of hot-spots, associated educational material and other suitable material. Element 104A can be generated after image data defining form 100 has been received and used to generate a user-selectable display, such as where an input/output device is used to select parts of form 100 and to identify those parts as element 104A.

Once element 104A has been identified, the user can be prompted to provide input for representation 106A. In one exemplary embodiment, representation 106A can include coordinates of the parts of document 102 that are associated with element 104A, a description of element 104A (such as a narrative of where it is located on form 102 and how it got there), and other suitable data. After entry of representation 106A, the user can be prompted to enter definition 108A. In one exemplary embodiment, definition 108A can be used to define the field that is used to hold a value associated with element 104A. After representation 106A has been defined, the user can be prompted to enter record 110A. In one exemplary embodiment, record 110A can include state data fields that identify who edited element 104A, how element 104A was edited, when element 104A was edited, the context during which editing took place (such as review, pre-closing, closing) and other suitable state record data.

In this regard, the term “closing” as used herein means the completion of a transaction that is effected by execution of all of the documents that are associated with the transaction. In this regard, the term closing is being used in accordance with its ordinary meaning in regards to closing of transactions, which is generally understood to mean execution of all of the documents that are required for a transaction to be completed, and not the execution of a subset of those documents that is less than the entire set. While documents can be executed in advance of closing, a transaction is generally not considered to be closed until all of the necessary documents have been executed. Post-closing obligations can be imposed by those documents, but in general, unless all of the documents required to complete a transaction have been executed, the transaction is not considered to be closed. One of ordinary skill in the art will recognize that closing a transaction is an important stage in the transaction, and that the failure of the transaction to close because of the inadvertent failure to execute all documents that are necessary to close a transaction is a serious problem, but one that happens frequently when transactions are closed using printed documents.

Likewise, elements 104N, each having associated representations 106N, definitions 108N and records 110N can be identified and generated for other parts of document 102 that are needed to be used for processing of real estate transactions or other suitable transactions.

FIG. 2 is a diagram of an algorithm 200 for creating a document for a transaction in accordance with an exemplary embodiment of the present disclosure. Algorithm 200 can be implemented in hardware or a suitable combination of hardware and software, and can be one or more algorithms operating on a processor.

Algorithm 200 begins at 202, where a document is scanned in to convert it to an electronic format. In one exemplary embodiment, 202 can be implemented as an object having associated data, operational attributes (such as user selectable controls and state sequences associated with the user selectable controls) and display attributes (such as text, graphics, colors and associated sequences) such as a user control to operate a scanning device that identifies the scanned document as a new form to be processed. The algorithm then proceeds to 204.

At 204, an element is identified, such as by demarcation of an area on the scanned form using a user interface control, by selection of text, or in other suitable manners. In one exemplary embodiment, 204 can be implemented using an object that has associated data, operational attributes and display attributes, such as a user control that is used to define a new element and to activate entry of associated data. The algorithm then proceeds to 206.

At 206, one or more representation fields are defined. In one exemplary embodiment, the representation fields can include a field for the coordinates of the element, a description of the element (such as a narrative of where it is located on the form and how it got there), and other suitable data. In another exemplary embodiment, 206 can be implemented using an object that has associated data, operational attributes and display attributes, such as a user control that is used to define representation fields for an element and to activate entry of associated data. The algorithm then proceeds to 208.

At 208, one or more definition fields are defined. In one exemplary embodiment, the definition fields can include the size of the field that is used to hold a value associated with the element and other suitable data. In another exemplary embodiment, 208 can be implemented using an object that has associated data, operational attributes and display attributes, such as a user control that is used to define definition fields for an element and to activate entry of associated data. The algorithm then proceeds to 210.

At 210, one or more record fields are defined. In one exemplary embodiment, the record fields can include data fields that identify who edited the element data fields, how the element data fields were edited, when the element data fields were edited, the context during which editing took place (such as review, pre-closing, closing) and other suitable record data. In one exemplary embodiment, 210 can be implemented using an object that has associated data, operational attributes and display attributes, such as a user control that is used to define record fields for an element and to activate entry of associated data. The algorithm then proceeds to 212.

At 212, it is determined whether additional elements and associated representation, definition and record fields need to be generated. If it is determined that there are additional elements, the algorithm returns to 204, otherwise the algorithm proceeds to 214. In one exemplary embodiment, 212 can be implemented using an object that has associated data, operational attributes and display attributes, such as a user control that is used to select entry of additional elements or completion of the document.

In operation, algorithm 200 can be used to generate a document for electronic process validation, such as to enter real estate documents, title documents or other suitable documents.

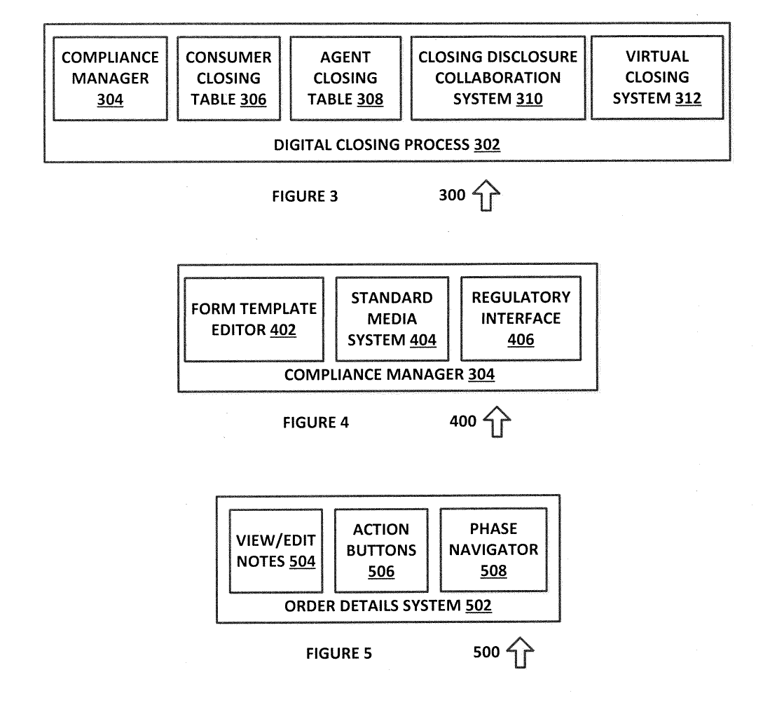

FIG. 3 is a diagram of a system 300 for a digital closing process in accordance with an exemplary embodiment of the present disclosure. System 300 includes digital closing process 302, compliance manager 304, consumer closing table 305, agent closing table 308, closing disclosure collaboration system 310 and virtual closing system 312, each of which can be implemented in hardware or a suitable combination of hardware and software, and which can be one or more software systems operating on a processor. In one exemplary embodiment, system 300 can be implemented as one or more objects, each having associated data, operational attributes and display attributes, which are used to provide associated user controls on an interface, such as a touch screen interface, a video terminal or other suitable interfaces.

Compliance manager 302 provides user controls to allow a user to select compliance management functions, including editing form templates, applying media to forms, managing a media library and performing other compliance functions. In one exemplary embodiment, compliance manager 302 can be generated on a user display for predetermined users, such as to restrict access to compliance manager 302 to users associated with electronic process validation. In this exemplary embodiment, access can be restricted to settlement agents, lenders and regulators, or other suitable parties can also or alternatively be included.

Consumer closing table 306 provides user controls to allow a user to select to review closing documents, to review educational materials associated with the closing documents, and to perform other compliance functions. In one exemplary embodiment, consumer closing table 306 can be generated on a user display for predetermined users, such as to restrict access to consumer closing table 306 to users associated with the consumers involved in the transaction. In this exemplary embodiment, access can be restricted to buyers and sellers, or other suitable parties can also or alternatively be included. The user can be allowed to electronically sign the documents, such as after the user has completed viewing the educational materials, after the user has configured an electronic signature, or in other suitable manners.

Agent closing table 308 provides user controls to allow a user to select and prepare closing documents, to provide educational materials associated with the closing documents, and to perform other compliance functions. In one exemplary embodiment, agent closing table 308 can be generated on a user display for predetermined users, such as to restrict access to agent closing table 308 to users associated with the settlement agent, lenders and other suitable agents involved in the transaction. The user can be allowed to review electronically signed documents, to respond to questions from a buyer, or to perform other suitable functions.

Closing disclosure collaboration system 310 provides a user control that allows the user to determine the current status of documents and data that will be required at the closing of a transaction. In one exemplary embodiment, closing disclosure collaboration system 310 can be generated on a user display for predetermined users, such as to restrict access to closing disclosure collaboration system 310 to users associated with preparing a closing disclosure document. In this exemplary embodiment, a user can have a predetermined role in the closing transaction, such as a realtor, a settlement agent, a lender or other suitable roles, and closing disclosure collaboration system 310 can include access restrictions that allow predetermined parties to view or edit predetermined documents or data fields in the documents. Closing disclosure collaboration system 310 can include a secure data feed system for communications between a lender and a settlement agent, to allow the settlement agent to determine the status of funds for a transaction.

Virtual closing system 312 allows a user to access a predetermined set of electronic documents in a closing environment, such as using a Docupad or other suitable devices. In one exemplary embodiment, virtual closing system 312 can be generated on a user display for predetermined users, such as to restrict access to virtual closing system 312 to users associated with a closing transaction. In this exemplary embodiment, a user can have a predetermined role in the closing transaction, such as a settlement agent, and virtual closing system 312 can include access restrictions that allow predetermined parties to view or edit predetermined documents in the set of documents, or predetermined data fields in the set of documents. Virtual closing system 312 can stage the set of documents for a closing of a transaction in a predetermined order, and can prevent a user from navigating from a current document to another document prior to execution of the current document. In another exemplary embodiment, virtual closing system 312 can allow a user to navigate to another document from a current document, but can prevent a transaction record for a closing from being updated until all necessary documents have been executed. In this manner, virtual closing system 312 can be used for a series of closings for unrelated transactions, and can prevent documents from one transaction from being inadvertently included in another transaction, from being inadvertently omitted from a transaction, or from causing other problems that can prevent a transaction from closing, such as by generating an indication when each of the documents that are necessary for a transaction to close have been executed, and also by preventing documents for a new transaction from being accessed until all of the documents for the current transaction have been executed. Virtual closing system 312 can include an override to allow a current transaction to be terminated without closing, and termination can generate a warning in consumer closing table 306, agent closing table 308, or other suitable warnings.

FIG. 4 is a diagram of a system 400 for compliance management in accordance with an exemplary embodiment of the present disclosure. System 400 includes compliance manager 304, form template editor 402, standard media system 404, media library manager 406 and regulatory interface 408, each of which can be implemented in hardware or a suitable combination of hardware and software, and which can be one or more software systems operating on a processor. In one exemplary embodiment, system 400 can be implemented as one or more objects, each having associated data, operational attributes and display attributes, which are used to provide associated user controls on an interface, such as a touch screen interface, a video terminal or other suitable interfaces.

Form template editor 402 allows a user to provide educational media to one or more elements of an electronic form or other suitable parts of an electronic form. In one exemplary embodiment, form template editor 402 can be generated on a user display for predetermined users, such as to restrict access to form template editor 402 to users associated with managing the content and structure of electronic forms. In this exemplary embodiment, form template editor 402 can include one or more user selectable controls that allow the user to add, delete or edit educational media associated with predetermined fields of a document.

Standard media system 404 allows a user to edit educational media that is used in one or more elements of one or more electronic forms. In one exemplary embodiment, standard media system 404 can be generated on a user display for predetermined users, such as to restrict access to standard media system 404 to users associated with managing the content and structure of educational media for forms. In this exemplary embodiment, standard media system 404 can include one or more user selectable controls that allow the user to add, delete or edit educational media in a library, such as education media that is associated with a plurality of different forms and that is viewed by consumers prior to execution of the forms.

Regulatory interface 406 allows a user to provide regulatory media content that is used in one or more elements of one or more electronic forms. In one exemplary embodiment, regulatory interface 406 can be generated on a user display for predetermined users, such as to restrict access to regulatory interface 406 to users associated with a regulatory agency. In this exemplary embodiment, regulatory interface 406 can include one or more user selectable controls that allow the user to add, delete or edit educational media in a library, such as education media that is provided by a regulatory agency for use by consumers prior to execution of one or more forms.

In operation, system 400 allows one or more users to ensure compliance with regulatory requirements by providing educational material within forms, and also allows user to edit the educational material and to obtain regulatory input and approval of educational material.

FIG. 5 is a diagram of a system 500 for order data access in accordance with an exemplary embodiment of the present disclosure. System 500 includes order details system 502, header navigation system 504, view/edit notes system 506, action buttons 508 and phase navigator 510, each of which can be implemented in hardware or a suitable combination of hardware and software, and which can be one or more software systems operating on a processor. In one exemplary embodiment, system 500 can be implemented as one or more objects, each having associated data, operational attributes and display attributes, which are used to provide associated user controls on an interface, such as a touch screen interface, a video terminal or other suitable interfaces.

Order details system 502 allows a user to access one or more orders associated with a user account. In one exemplary embodiment, order details system 502 can be generated on a user display for predetermined users, such as to restrict access to order details system 502 to users having an account. In this exemplary embodiment, order details system 502 can include one or more user selectable controls that allow the user to list open and closed orders, to sort the open and closed orders (such as by date, address or in other suitable manners), to view the sales amount, buyer or seller information, a loan amount, a closing date, a countdown indicator to a future closing date or other suitable data. Order details system 502 can also allow a user to set up a new order for a transaction, such as by providing party data for the transaction, by identifying a set of electronic documents that are needed to close the transaction, by associating the order with an account, or in other suitable manners.

View/edit notes system 504 allows a user to create, edit or delete notes associated with an order. In one exemplary embodiment, view/edit notes system 504 can be generated on a user display for predetermined users, such as to restrict access to view/edit notes system 504 to users having an account. In this exemplary embodiment, view/edit notes system 504 can include one or more user selectable controls that allow the user to select a person to send a note to (such as a drop down menu that lists all persons associated with an order), to edit or delete a note, or to perform other suitable functions.

Action buttons 506 allows a user to take selected actions within the system. In one exemplary embodiment, action buttons 506 can be generated on a user display for predetermined users, such as to restrict access to action buttons 506 to users having an account. In this exemplary embodiment, action buttons 506 can include one or more user selectable controls that allow the user to view a status indicator that reflects whether a person is online, a chat feature control that allows the user to chat with another user, an invite control that allows the user to invite a person to participate in a transaction, or other suitable controls.

Phase navigator 508 allows a user to navigate between phases of a transaction, such as to view a system tour, to view pre-closing documents and educational materials, to view closing documents and educational materials, to view post-closing items or products, or to access other suitable phases. In one exemplary embodiment, phase navigator 508 can be generated on a user display for predetermined users, such as to restrict access to phase navigator 508 to users having an account. In this exemplary embodiment, phase navigator 508 can include one or more user selectable controls that allow the user to select a phase, to see whether action items associated with the phase have been completed or are still outstanding, or other suitable controls. In addition, phase navigator 508 can be used to audit a closing process, such as to allow a regulator to review the type and sequence of documents, the information that is provided to a consumer, the actions required by lenders or settlement agents, and other suitable information. The audit function can also be performed during a transaction, such as to allow a regulator to review the status of a pending transaction to verify that it complies with relevant laws and regulations.

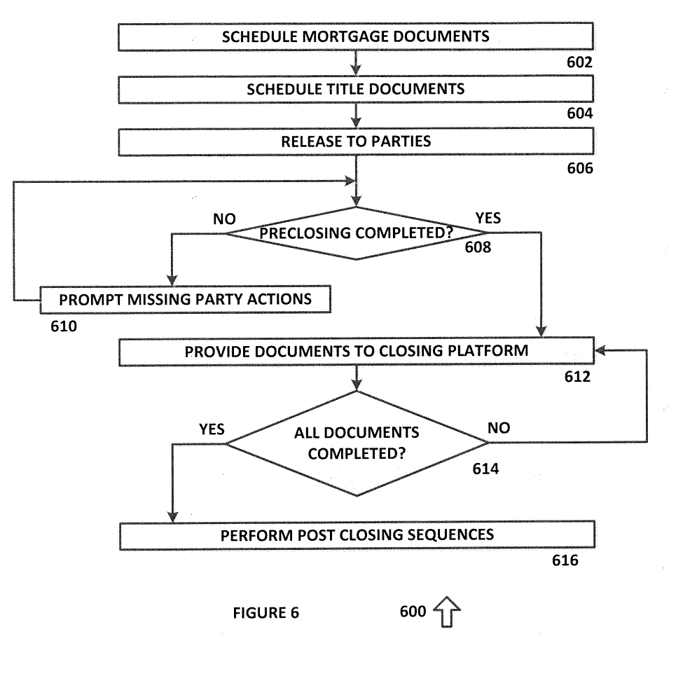

FIG. 6 is a diagram of an algorithm 600 for managing a virtual closing environment in accordance with an exemplary embodiment of the present disclosure. Algorithm 600 can be implemented in hardware or a suitable combination of hardware and software, and can be one or more algorithms operating on a processor.

Algorithm 600 begins at 602, where mortgage documents for a transaction are scheduled. In one exemplary embodiment, the mortgage documents that are required for the transaction can be selected by a user, such as a realtor, a template of standard mortgage documents for a type of transaction can be selected, or other suitable scheduling processes can also or alternatively be used. The algorithm then proceeds to 604.

At 604, title documents for the transaction are scheduled. In one exemplary embodiment, the title documents that are required for the transaction can be selected by a user, such as a settlement agent, a template of standard title documents for a type of transaction can be selected, or other suitable scheduling processes can also or alternatively be used. The algorithm then proceeds to 606.

At 606, the mortgage documents, title documents and other suitable documents are released to one or more parties associated with a transaction, such as a seller, a buyer, a lender, a regulator or other suitable parties. In one exemplary embodiment, the documents can be released by entering a user identifier for each party in an associated field for a transaction, where an icon that can be selected by the user to access to the document is generated when the associated user accesses a web site or other user interface. Each time a user accesses a document, the associated data is logged, such as the network address from which the access occurred, the date and time of the access, the data fields that were modified, the educational materials that were viewed, or other suitable data. Likewise, other suitable processes can also or alternatively be used. The algorithm then proceeds to 608.

At 608, it is determined whether pre-closing has been completed. In one exemplary embodiment, the status of pre-closing actions that are required by one or more parties can be periodically checked, such as on a daily basis, at a predetermined time such as a number of days before closing, or in other suitable manners. It can likewise be determined whether any required data fields are blank, whether a buyer or seller has viewed any required educational material, or whether other required data has not been provided or required actions have not been completed. If it is determined that pre-closing has not been completed, the algorithm proceeds to 610 where parties with outstanding action items are prompted. In one exemplary embodiment, an email, text message or other suitable form of electronic message can be generated that identified outstanding action item, an alert can be provided to an agent to follow up with a party, or other suitable prompts can also or alternatively be used. The algorithm then returns to 608. If it is determined that pre-closing has been completed, the algorithm proceeds to 612.

At 612, the closing documents are provided to a closing platform, such as a Docupad or other suitable platforms. In addition, access to escrow fund status data can be provided to a settlement agent, or other suitable processes can also or alternatively be used, such as to release control over a document to a settlement agent so as to lock out all other parties from making further changes. The algorithm then proceeds to 614.

At 614, it is determined whether all documents that are required for closing have been completed, such as whether a signature has been received in each signature field, whether all data has been provided in associated data fields, or whether other suitable data or processes have been completed. If it is determined that all documents have not been completed, the algorithm returns to 612, otherwise the algorithm proceeds to 616 where post-closing sequences are performed.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for electronic transaction processing, comprising:
a plurality of electronic documents, each of the electronic documents having state and a plurality of elements, each element having one or more representation data field with an associated state, one or more definition data field with an associated state and one or more record data field with an associated state;
a consumer closing table configured to provide access to a subset of the electronic documents and to allow a user that has been associated with the subset of the electronic documents to view predetermined educational materials associated with one or more of the elements; and
a closing disclosure collaboration system configured to provide access to a closing disclosure document of the plurality of electronic documents and to allow a first user that has been associated with the closing disclosure document to edit predetermined data fields associated with a settlement agent and to modify each of the associated states of each settlement agent edited data field to reflect any changes, and to allow a second user that has been associated with the closing disclosure document to edit predetermined data fields associated with a lender and to modify each of the associated states of each lender edited data field to reflect any changes.

2. The system of claim 1 further comprising a buyer's agent closing table configured to provide access to a second subset of the electronic documents and to allow a buyer's agent that has been associated with the second subset of the electronic documents to edit predetermined data fields associated with one or more of the elements and to modify each of the associated states of each buyer's agent edited data field to reflect any changes.

3. The system of claim 1 further comprising a compliance manager configured to provide access to the plurality of electronic documents and associated state data, and the educational materials at any state in a transaction.

4. The system of claim 3 wherein the compliance manager further comprises a form template editor configured to allow a predetermined user to modify one or more fields of a form template.

5. The system of claim 3 wherein the compliance manager further comprises a standard media system configured to receive media in one of a plurality of formats and to convert the media into a single predetermined format.

6. The system of claim 3 wherein the compliance manager further comprises a regulatory interface configured to provide access to the plurality of electronic documents and associated state data, and the educational materials at any state in a transaction, to a predetermined user.

7. The system of claim 1 further comprising a virtual closing system configured to sequence the plurality of electronic documents and to generate an indicator when each of the plurality of electronic documents has been executed.

8. The system of claim 1 further comprising a virtual closing system configured to sequence the plurality of electronic documents and to generate a warning when closing is terminated prior to execution of each of the plurality of electronic documents.

9. The system of claim 1 further comprising an order details system configured to receive an account identifier for a user and to generate a display that includes each of the orders associated with the account and a status for each of the orders indicating whether the order is open or closed.

10. The system of claim 1 further comprising an action button control associated with each of the electronic documents, the action button control comprising an object having associated data, operational attributes and display attributes that generates a message associated with the electronic document for another user.

11. A system for electronic transaction processing, comprising:
a plurality of electronic documents, each of the electronic documents having state and a plurality of elements, each element having one or more representation data field with an associated state, one or more definition data field with an associated state and one or more record data field with an associated state, each of the electronic documents configured to be displayed on a user interface as an object having associated data, functional attributes and graphical attributes;
a consumer closing table configured to provide access to a subset of the electronic documents and to allow a user that has been associated with the subset of the electronic documents to view predetermined educational materials associated with one or more of the elements, the consumer closing table further configured to be displayed on the user interface as an object having associated data, functional attributes and graphical attributes; and
a closing disclosure collaboration system configured to provide access to a closing disclosure document of the plurality of electronic documents and to allow a first user that has been associated with the closing disclosure document to edit predetermined data fields associated with a settlement agent and to modify each of the associated states of each settlement agent edited data field to reflect any changes, and to allow a second user that has been associated with the closing disclosure document to edit predetermined data fields associated with a lender and to modify each of the associated states of each lender edited data field to reflect any changes, the closing disclosure collaboration system further configured to be displayed on the user interface as an object having associated data, functional attributes and graphical attributes.

12. The system of claim 11 further comprising a buyer's agent closing table configured to provide access to a second subset of the electronic documents and to allow a buyer's agent that has been associated with the second subset of the electronic documents to edit predetermined data fields associated with one or more of the elements and to modify each of the associated states of each buyer's agent edited data field to reflect any changes, the buyer's agent closing table further configured to be displayed on the user interface as an object having associated data, functional attributes and graphical attributes.

13. The system of claim 11 further comprising a compliance manager configured to provide access to the plurality of electronic documents and associated state data, and the educational materials at any state in a transaction, the compliance manager further configured to be displayed on the user interface as an object having associated data, functional attributes and graphical attributes.

14. The system of claim 13 wherein the compliance manager further comprises a form template editor configured to allow a predetermined user to modify one or more fields of a form template, the form template editor further configured to be displayed on the user interface as an object having associated data, functional attributes and graphical attributes.

15. The system of claim 13 wherein the compliance manager further comprises a standard media system configured to receive media in one of a plurality of formats and to convert the media into a single predetermined format.

16. The system of claim 13 wherein the compliance manager further comprises a regulatory interface configured to provide access to the plurality of electronic documents and associated state data, and the educational materials at any state in a transaction, to a predetermined user, the regulatory interface further configured to be displayed on the user interface as an object having associated data, functional attributes and graphical attributes.

17. The system of claim 11 further comprising a virtual closing system configured to sequence the plurality of electronic documents and to generate an indicator when each of the plurality of electronic documents has been executed, the virtual closing system further configured to be displayed on the user interface as an object having associated data, functional attributes and graphical attributes.

18. The system of claim 11 further comprising a virtual closing system configured to sequence the plurality of electronic documents and to generate a warning when closing is terminated prior to execution of each of the plurality of electronic documents, the virtual closing system further configured to be displayed on the user interface as an object having associated data, functional attributes and graphical attributes.

19. The system of claim 11 further comprising an order details system configured to receive an account identifier for a user and to generate a display that includes each of the orders associated with the account and a status for each of the orders indicating whether the order is open or closed, the order details system further configured to be displayed on the user interface as an object having associated data, functional attributes and graphical attributes.

20. The system of claim 11 further comprising an action button control associated with each of the electronic documents, the action button control comprising an object having associated data, operational attributes and display attributes, that generates a message associated with the electronic document for another user.
